(19) United States
(12) Patent Application Publication
(10) Pub. No.: US 2005/0237165 A1
(43) Pub. Date: Oct. 27, 2005

(54) Lighted banner holder for vehicles

(75) Inventor: David Shimoni, Tel Aviv (IL)

Correspondence Address: DR. MARK FRIEDMAN LTD.;C/o Bill Polkinghorn, 9003 Florin Way, Upper Marlboro, MD, 20772, US

(73) Assignee: RONIT FLAGS OF THE WORLD LTD.

(21) Appl. No.: 11/110,853

(22) Filed: Apr. 21, 2005

Related U.S. Application Data
(60) Provisional application No. 60/563,827, filed on Apr. 21, 2004.

(51) Int. Cl. B60Q 1/00

(52) U.S. Cl. 340/425.5; 362/543

(57) ABSTRACT

The present invention is an integrally formed banner holder with a lighting system deployed at the extremity of the banner holding stem. The lighting system may include a single light or a plurality of lights. The lighting system may be configured such that the lights are on constantly or blink. When a plurality of lights are configured to blink, the blinking may be in any one or combination of blinking patterns such as, but not limited to, all lights blinking together, blinking in sequence, and random blinking

This application claims priority from U.S. Provisional Patent Application 60/563,827 filed 21 Apr. 2004.

### FIELD AND BACKGROUND OF THE INVENTION

The present invention relates to banner or flag holders for vehicles and, in particular, it concerns a lighted banner holder.

It is known to attach banners and/or flags to vehicles, especially to radio antennae. This usually results in damage to the antenna, since they are not designed to withstand the aerodynamic effects of such attachments.

A number of devices have be suggested over the years to provide a suitable alternative, most of with are removably attached to the vehicle using nut and bolt arrangements that require tools and may loosen during use. Further, these devices are generally constructed from a number of parts and require adjustments to bring the pole portion into an upright position. Here too, the interconnection of the parts and the adjustments may loosen or disengage over time, thereby require tightening. In a worst case scenario, the device may become inoperable and un-repairable.

Another drawback to the device of prior art is that of bringing attention to the banner, especially in low lighting situations.

There is therefore a need for a lighted banner holder for vehicles. It would be of benefit if the vehicle attachment base and the banner holding extension where integrally formed.

### BRIEF DESCRIPTION OF THE DRAWINGS

The invention is herein described, by way of example only, with reference to the accompanying drawings, wherein:

FIG. 1 is an isometric view of a lighted banner holder constructed and operative according to the teachings of the present invention;

FIG. 2 is an isometric view of a banner holder lighting system constructed and operative according to the teachings of the present invention; and

FIG. 2A is a top elevation of the banner holder lighting system of FIG. 2.

### DESCRIPTION OF THE PREFERRED EMBODIMENTS

The present invention is a light banner holder for vehicles.

The principles and operation of a lighted banner holder for vehicles according to the present invention may be better understood with reference to the drawings and the accompanying description.

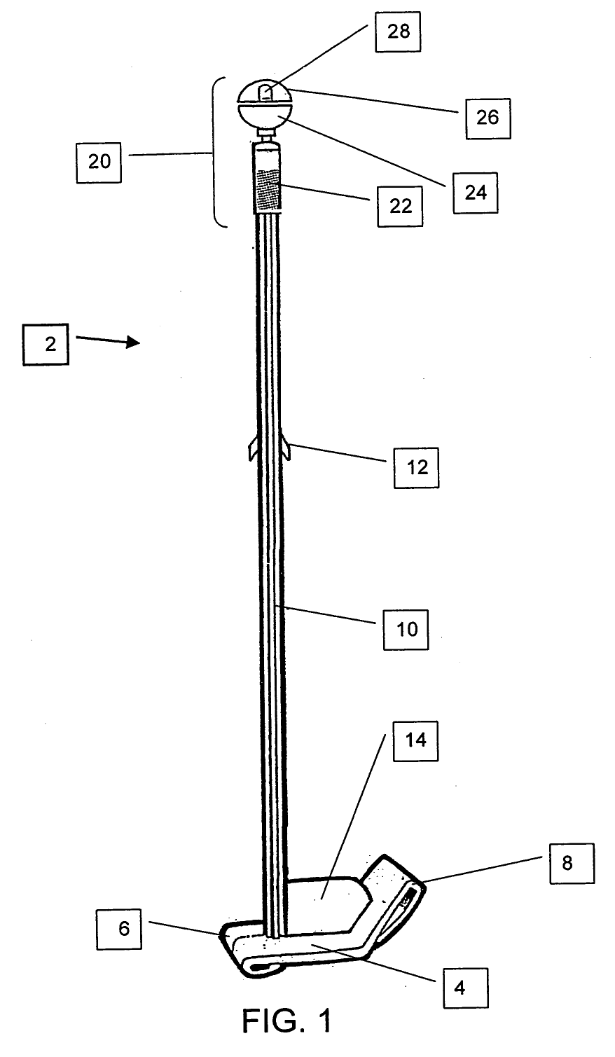

Referring now to the drawings, FIG. 1 shows a flag holder 2 that includes a base 4 for attaching the banner holder 2 to a supporting surface (not shown). The base 4 includes a first fastener 6 for attaching the banner holder 2 to substantially horizontal supporting surfaces such as, but not limited to, hoods, trunks, and fenders of motor vehicles. Preferably, the first fastener 6 is configured as a clip that is integrally formed with the base 4.

Optionally, the base 4 also includes a second fastener 8 that is configured for attaching the banner holder 2 to non-horizontal supporting surfaces such as, but not limited to, motor vehicle windows. Preferably, the second fastener 8 is configured as a clip that is integrally formed with the base 4.

Extending from the base 2 is an elongated stem 10 attaching a banner or flag (not shown). Preferably, stem 10 includes a least one securing tab 12 extending outwardly from the stem 10, so as to facilitate secure installation of a banner or flag.

A lighting system 20 is configured at the extreme end of the stem 10. Preferably, the lighting system 20 includes at least a connector 22; a lighting system housing 24, which house batteries, electronic circuitry, and at least one light emitting element 28; and a transparent lighting system cap 26. It should be noted that the lighting system housing 24 may also be transparent. The connector 22 is configured for attaching the lighting system 20 to the stem 10. This attachment may be, by non-limiting example, by pressure fit, screw threads, or a retaining clip or screw. It should be noted that the connector 22 and the lighting system housing 24 may be interconnected or they may be integrally formed. Alternatively, the connector may be integrally formed with the stem 10 and configured for interconnection with lighting system housing 24. It will be understood that both the connector 22 and the lighting system housing 24 may be integrally form with the stem 10 since access to the electrical component so the lighting system is preferably by removal of the transparent lighting system cap 26.

The lighting system housing 24 preferably has a circular cross-sectional contour. However, it may be configured with substantially any cross-sectional contour such as, but not limited to, square, substantially any polygonal shape, oval, and substantially any closed curve. It will be understood that the transparent lighting system cap 26, therefore, is configured with a corresponding cross-sectional contour. Further, the transparent lighting system cap 26 may be configured as a curved dome (as illustrated herein) or as an angular box-like cap. The transparent lighting system cap 26 may be clear or colored.

The lighting system may include a single light 28 or a plurality of lights. The lights may be white or colored. The lighting system circuitry may be configured such that the lights are on constantly or blink. When a plurality of lights are configured to blink, the blinking may be in any one or combination of blinking patterns such as, but not limited to, all lights blinking together, blinking in sequence, and random blinking. A switch (not shown) may be provided so as to allow turning the lighting system on and off, and when applicable, to alternate between blinking patterns. Alternatively, two switches may be employed.

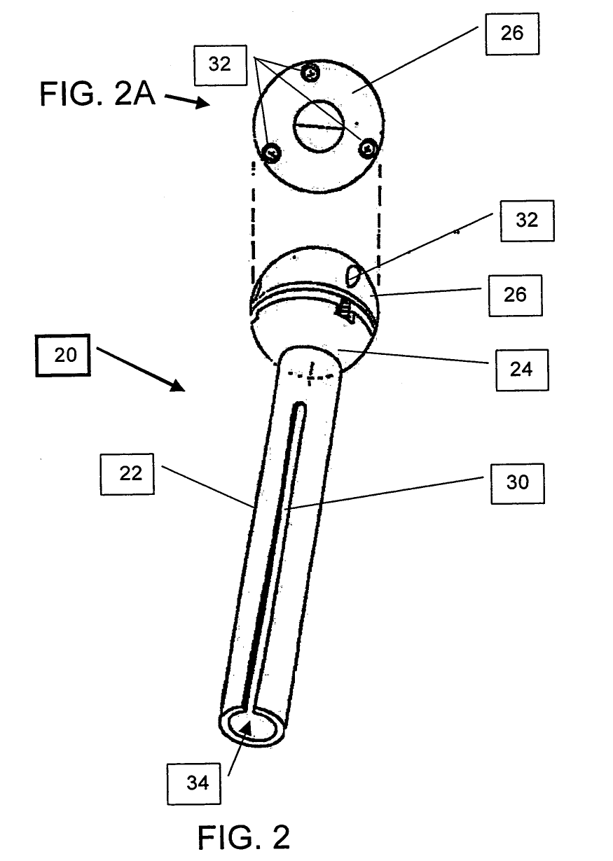

In a preferred embodiment of the lighting system 20 illustrated in FIGS. 2 and 2A, the connector portion 22 is configured to accept insertion of at least a portion of the extreme end of the stem 10 into the hollow region 34. Slot 30 is provided in a portion of the circumference of the connector portion 22 such that at least a portion of the banner or flag (not shown) may pass through, thereby maintaining the shape of the banner while holding it in place. The opening of the slot 30 is preferably in the range of 3-5 degrees of the circumference of the connector portion 22; however, a range of 3-160 degrees of a circumference of the connector portion 22 is within the scope of the present invention. Here too, as mentioned above, the lighting system housing 24 and the connector portion 22 may be integrally formed or they may be configured as two interconnected pieces.

Also illustrated in this embodiment of the lighting system 20, the lighting system housing is configured with a transparent lighting system cap 26. The interconnection between the lighting system cap 26 and the lighting system housing 24 is such that the lighting system cap 26 is spaced apart from and displaceable toward the lighting system housing 24. This is accomplished by screws 32 and coil springs 36. Displacement of the lighting system cap 26 toward the lighting system housing 24 activates a switch (not shown) deployed within the lighting system housing 24, thereby alternately turning on and off the light emitting element 28. It will be appreciated that the lighting system housing 24 may also be transparent, thereby enlarging the visibly lighted area of the lighting system 20.

The base 4 preferably includes a support element 14. Support element 14 may be integrally formed with, or attached to, the base 4 and at least a portion of the stem 10, thereby strengthening the interconnection of the base 4 and the stem 10. The support element 14 may be configures so as to provide at least one surface upon which promotional material such as, but not limited to, logos, decals, and advertising materials may be displayed.

In a preferred embodiment of the present invention, the base 4, the first and second fasteners 6 and 8, the support element 14, the stem 10 and the securing tabs 12 are integrally form from plastic polymer material.

In the preferred embodiment of the present invention illustrated herein, a banner or flag may be attached to the banner holder 2 by first removing the lighting system 20, sliding an attachment sleeve of the flag over the end of the stem 10 and the securing tabs 12, and then replacing the lighting system 20.

It will be appreciated that the above descriptions are intended only to serve as examples and that many other embodiments are possible within the spirit and the scope of the present invention.

1. A holder for attaching a banner to a vehicle comprising:
(a) a stem for attaching the banner;
(b) a base integrally formed with a first extremity of said stem;
(c) a first fastener, integrally formed with said base, for securing sad base to the vehicle; and
(d) a lighting system releasably attached to a second extremity of said stem.

2. The holder of claim 1, wherein said stem further includes a securer integrally formed on said stem, said securer configured to secure the flag on said stem.

3. The holder of claim 1, wherein said base includes a second fastener.

4. The holder of claim 3, wherein said first and second fasteners are clips.

5. The holder of claim 1, further comprising a support attached to said stem and said base.

6. The holder of claim 5, wherein said support is a promoter support.

7. The holder of claim 1, wherein said lighting system includes a connector portion, a lighting system housing and at least one light emitting element deployed within said lighting system housing; and at least a portion of said lighting system housing is transparent.

8. The holder of claim 7, wherein said connector portion is configured so as to accept insertion of at least a portion of said second extremity of said stem.

9. The holder of claim 8, wherein said connector portion is configured with a slot such that a portion of the banner passes through said slot.

10. The holder of claim 9, wherein an opening of said slot is in a range of 3-160 degrees of a circumference of said connector portion.

11. The holder of claim 7, wherein said lighting system housing is configured with a transparent lighting system cap.

12. The holder of claim 11, wherein interconnection between said lighting system cap and said lighting system housing is such that said lighting system cap is spaced apart from and displaceable toward said lighting system housing, and displacement of said lighting system cap toward said lighting system housing activates a switch thereby alternately turning on and off said light emitting element.

13. A lighting system for releasable attachment to the stem of a banner holder, the lighting system comprising:
(a) a connector portion configured to accept insertion of at least a portion of an extremity of the stem, and said connector portion is configured with a slot such that a portion of the banner passes through said slot;
(b) a lighting system housing, at least a portion of which is transparent; and
(c) at least one light emitting element deployed within said lighting system housing.

14. The holder of claim 13, wherein an opening of said slot is in a range of 3-160 degrees of a circumference of said connector portion.

15. The holder of claim 13, wherein said lighting system housing is configured with a transparent lighting system cap.

16. The holder of claim 15, wherein interconnection between said lighting system cap and said lighting system housing is such that said lighting system cap is spaced apart from and displaceable toward said lighting system housing, and displacement of said lighting system cap toward said lighting system housing activates a switch thereby alternately turning on and off said light emitting element.

17. A lighting system for releasable attachment to the stem of a banner holder, the lighting system comprising:
(a) a connector portion configured to accept insertion of at least a portion of an extremity of the stem;
(b) a lighting system housing, at least a portion of which is transparent; and
(c) at least one light emitting element deployed within said lighting system housing.
wherein said lighting system housing is configured with a transparent lighting system cap, and interconnection between said lighting system cap and said lighting system housing is such that said lighting system cap is spaced apart from and displaceable toward said lighting system housing, and displacement of said lighting system cap toward said lighting system housing activates a switch thereby alternately turning on and off said light emitting element.

18. The holder of claim 17, wherein said connector portion is configured with a slot such that a portion of the banner passes through said slot.

19. The holder of claim 18, wherein an opening of said slot is in a range of 3-160 degrees of a circumference of said connector portion.
